(19) United States
(12) Patent Application Publication
(10) Pub. No.: US 2024/0086798 A1
(43) Pub. Date: Mar. 14, 2024

(54) STAFFING FORECASTING AND REALLOCATION SYSTEM

(71) Applicant: Nationwide Mutual Insurance Company, Columbus, OH (US)

(72) Inventors: Yi Cheng, Westerville, OH (US); Lance Michael Cunningham, Norwalk, IA (US); Diana Surtihadi, Dublin, OH (US)

(21) Appl. No.: 17/941,693

(22) Filed: Sep. 9, 2022

(51) Int. Cl. G06Q 10/06

(52) U.S. Cl. CPC G06Q 10/06312

(57) ABSTRACT

A method and system for generating work load predictions by a neural network for staffing scheduling. A database(s) can include neural network training data corresponding to the characteristics of a plurality of past trigger conditions, and a record of the actual work load associated with those past trigger conditions. The neural network can analyze the neural network training data, and, via machine learning, determine and/or refine an ad hoc model that can generate a predicted work load associated with an occurrence of the trigger condition. The predicted work load can be compared to a current staffing schedule that was developed via use of a base model. Based on differences in the predicted work load and current staffing scheduling, as well as rules and constraints regarding reallocation of workers, an updated staffing schedule can be generated, with changes to the staffing schedule being automatically communicated to client devices.

### FIELD OF INVENTION

The present application generally relates to staffing reallocation, and more particularly, a real-time solution to accurately forecast and reallocate work staffing in response to a prediction and/or detection of an occurrence of a trigger condition(s).

### BACKGROUND

Employers often seek to achieve sufficient levels of staffing of workers so as to provide customers with a satisfactory level of service in a cost efficient manner. Yet, even in normal operating conditions, determining the level of staffing that will attain a proper balance between achieving customer satisfaction and the associated economic costs, at least in terms of staff wages or salaries, can be challenging. Adding to such complexity is the occasional occurrence of unexpected events that trigger an increase in customer volume and/or customer demands. For example, while certain weather events can be anticipated to occur during certain seasons of the year, the actual timing, duration, and/or severity of such events may be unknown. Such uncertainties can increase the complexity of determining a staffing schedule that can adequately satisfy the changes in workload, if any, that can result as a consequence of such weather events.

Additionally, work schedules are often determined in advance of a forecasted, or an actual arrival, of such weather events. Thus, often, changes in work schedules that attempt to address the workloads associated with such weather events are reactionary, which can delay the timeliness of the response to the change in workload, and preclude timely communication of changes in work schedules to workers. Another issue commonly encountered is determining which workers, if any, should be reallocated from currently scheduled tasks to other tasks that may assist in handling an actual or anticipated change in workload.

### BRIEF SUMMARY

An aspect of an embodiment of the present application is a system for generating predictions by a neural network for staffing scheduling in response to a detection or prediction of a trigger condition. The system can include one or more databases that receive neural network training data corresponding to a plurality of characteristics for each of a plurality of past trigger conditions and a recorded work load associated with each of the plurality of past trigger conditions. The system can also include at least one processor and a memory coupled to the at least one processor. The memory can include instructions that, when executed by the at least one processor, cause the system to analyze, for continuous training of the neural network based on machine learning, the neural network training data to identify one or more work load patterns corresponding to one or more of the plurality of past trigger condition, and receive a notification of the trigger condition. Additionally, the instructions can also, when executed by the at least one processor, cause the system to receive, in response to notification of the trigger condition, a work load prediction from the neural network, the work load prediction based in part on the continuous training of the neural network and one or more characteristics of the trigger condition. Further, the instructions can also, when executed by the at least one processor, cause the system to compare the work load prediction with a current staffing schedule and, based at least in part on an outcome of the comparison, adjust one or more work schedules of the current staffing schedule, and automatically communicate the adjustment to the one or more work schedules to a client device.

Another aspect of an embodiment of the present application is a method for generating predictions by a neural network for staffing scheduling in response to a detection or prediction of a trigger condition. The method can include receiving, by one or more databases, neural network training data corresponding to a plurality of characteristics for each of a plurality of past trigger conditions and a recorded work load associated with each of the plurality of past trigger conditions. Additionally, the method can include analyzing, for continuous training of the neural network based on machine learning, the neural network training data to identify one or more work load patterns corresponding to one or more of the plurality of past trigger conditions. Further, a notification of the trigger condition can be received and, in response to notification of the trigger condition, a work load prediction can be received from the neural network, the work load prediction based in part on the continuous training of the neural network and one or more characteristics of the trigger condition. The work load prediction can be compared with a current staffing schedule and, based at least in part on an outcome of the comparison, one or more work schedules of the current staffing schedule can be adjusted. The method can also include automatically transmitting a signal communicating the adjusted one or more work schedules to a client device.

These and other aspects of the present invention will be better understood in view of the drawings and following detailed description.

### BRIEF DESCRIPTION OF THE DRAWINGS

The description herein makes reference to the accompanying figures wherein like reference numerals refer to like parts throughout the several views.

FIG. 1 illustrates an exemplary embodiment of an intelligent staff scheduling system;

FIG. 2 illustrates a simplified flowchart of a method that can be performed by the intelligent staff scheduling system in connection with reallocating work staff following detection of a trigger condition;

FIG. 3 illustrates a simplified flowchart of a method that can be performed by the intelligent staff scheduling system in connection with reallocating work staff in a call and/or claim center in response to the occurrence of a trigger condition;

FIG. 4 illustrates a simplified flowchart of a method that can be performed by the intelligent staff scheduling system in connection with reallocating work staff in response to a prediction of an upcoming trigger condition in the form of a weather event;

FIG. 5 illustrates a simplified flowchart of a method that can be performed by the intelligent staff scheduling system in connection with adjusting a reallocation of work staff as actual event characteristics are identified during a trigger condition; and

FIG. 6 illustrates a simplified flowchart of a method that can be performed by the intelligent staff scheduling system in connection with identifying variances between the predicted and actual work volumes different teams or groups of work staff experienced in connection with a trigger condition.

The foregoing summary, as well as the following detailed description of certain embodiments of the present application, will be better understood when read in conjunction with the appended drawings. For the purpose of illustrating the application, there is shown in the drawings, certain embodiments. It should be understood, however, that the present application is not limited to the arrangements and instrumentalities shown in the attached drawings. Further, like numbers in the respective figures indicate like or comparable parts.

### DESCRIPTION OF THE ILLUSTRATED EMBODIMENTS

In the Detailed Description herein, references to “one embodiment”, an “embodiment”, and “example embodiment”, etc., indicate that the embodiment described may include a particular feature, structure, or characteristic, by every embodiment may not necessarily include the particular feature, structure, or characteristic. Moreover, such phrases are not necessarily referring to the same embodiment. Further, when a particular feature, structure, or characteristic may be described in connection with an embodiment, it may be submitted that it may be within the knowledge of one skilled in art to affect such feature, structure, or characteristic in connection with other embodiments whether or not explicitly described.

The following Detailed Description refers to the accompanying drawings that illustrate exemplary embodiments. Other embodiments are possible, and modifications can be made to the embodiments within the spirit and scope of this description. Those skilled in the art with access to the teachings provided herein will recognize additional modifications, applications, and embodiments within the scope thereof and additional fields in which embodiments would be of significant utility. Therefore, the Detailed Description is not meant to limit the embodiments described below.

Embodiments herein generally relate to accurately identifying changes in staffing needs, as well as staffing reallocation based on those identified needs, in a real-time manner in response to one or more predicted, forecasted, and/or detected trigger conditions. In an exemplary embodiment, a call or claim center can typically be staffed using a base model that is based on how many inbound calls or claims are typically, and/or on average, expected to occur and/or received during such a working day for the current time of year. However, a call or claim center may experience, or anticipate, an increase in call and/or claim volume in response to a detected trigger condition, and/or based on a forecasted or predicted occurrence of a trigger condition, that may be related to a situation that is generally not typically experienced in an ordinary work day or time. In such a situation, actual and/or predicted characteristics of the trigger condition can identified and/or determined. Historical data associated with a similar trigger condition and/or similar trigger condition characteristics, as well as current work load conditions, can be utilized by an ad hoc event model to develop a prediction of an anticipated work level that may be experienced. According to certain embodiments, such an ad hoc model can be provided by a neural network and an associated self-learning model(s) or algorithm(s). According to certain embodiments, the neural network can be utilize in developing and utilizing a variety of self-learning models or algorithms, with different self-learning models or algorithms being associated with different types of trigger conditions, or similar types of trigger conditions but having a particular characteristic(s) that may differentiate the trigger conditions. Additionally, according to certain embodiments, the neural network can provide, or be used to determine, an indication of an anticipated work load, work hours, or staffing that may be associated with the occurrence of the trigger condition that may be at least partially based on, or, alternatively, independent of a determination(s) made by the base model. Further, such a prediction of anticipated work level can include, for example, an amount of work hours that may be anticipated as being needed to address the work volume that may occur in response to the occurrence of the detected or forecasted trigger condition. Additionally, the predicted work volume can be provided on an individual, department, group, team, and/or task level, so that particular staffing needs can be relatively precisely identified and evaluated. Further, an intelligent staffing computing device can identify whether a current staffing work schedule is, or is not, sufficient to satisfy the anticipated work level, as provided via use of the neural network. If the current staffing work schedule is insufficient, the intelligent staffing computing device can, utilizing predetermined rules or constraints, identify one or more individuals, work teams, and/or work groups that can be added to the work schedule and/or be reallocated from other tasks or jobs to supplement staffing so as to handle the anticipated work level with a particular selected or predetermined level of service quality. The intelligent staffing computing device can also be adapted to communicate changes or updates to employees and/or other work management systems or tools.

The accuracy of the anticipated work level prediction can be evaluated using at least data accumulated during the trigger condition so as to adjust and/or improve the accuracy of the neural network when responding to subsequent forecasted and/or detected trigger conditions. Additionally, according to certain embodiments, characteristics of the trigger condition, whether related to changes in the forecasted prediction for the trigger condition, or recorded characteristics of the actual trigger condition, can be generally continuously observed in connection with determining whether an updated prediction in the anticipated work level from the neural network should be determined and/or implemented, and/or if staffing scheduling should again be adjusted. Information regarding the trigger condition, including recorded characteristics of the trigger condition, the changes in the work schedule made in response to a predicted anticipated work level, and/or the accuracy of the predicted anticipated work level, can be recorded in a database for future use. Moreover, such information can assist in identifying patterns and/or relationships between such trigger conditions and the associated workloads or volumes and/or staffing needs, as well as trends regarding the timing of workloads or volumes when responding to the trigger condition or the associated impact of the trigger condition. Identification of such patterns, as well as possible refinement of the identified patterns as additional data or information is accumulated, can be utilized to improve the accuracy of the determinations made by the ad hoc model, and, moreover, by the neural network and associated self-learning model(s) or algorithm(s). Thus, the systems described herein can utilize an iterative process in which accumulated historical information regarding prior trigger conditions and the associated changes in work levels can be utilized to further improve the accuracy of at least staffing need predictions.

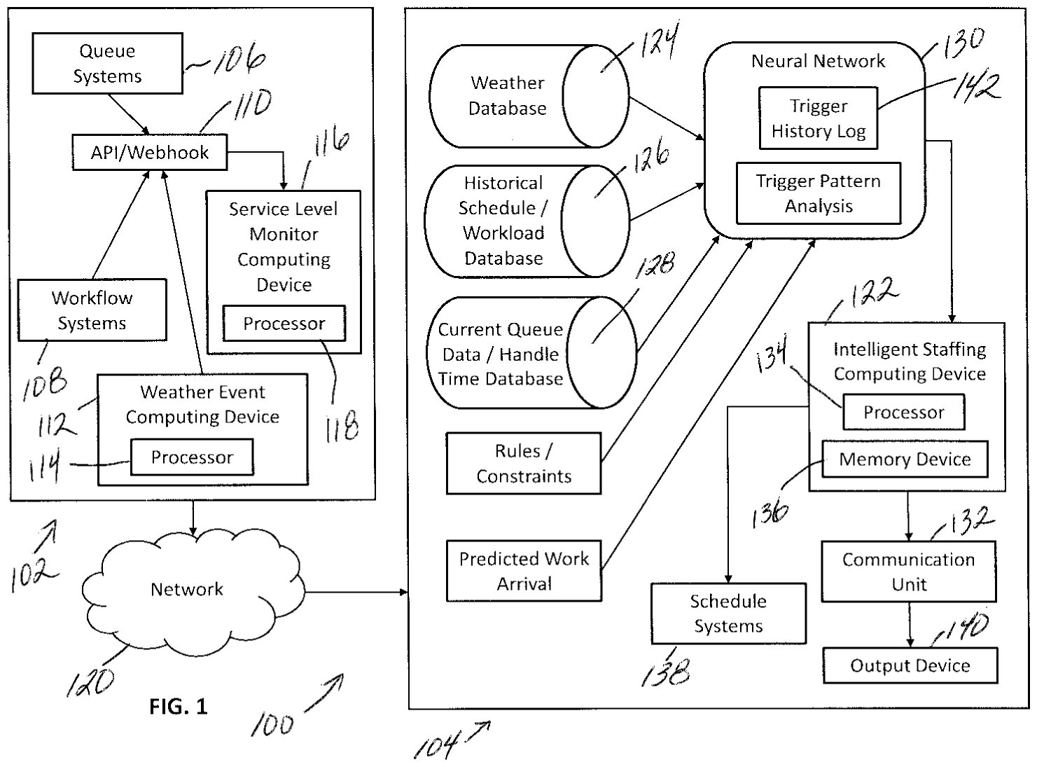

FIG. 1 illustrates an intelligent staff scheduling system 100 that can, for at least purposes of illustration, include an intraday system 102 and a scheduling management system 104. The intraday system 102 can generally be adapted to involve at least current or present operation of at least certain aspects of the intelligent staff scheduling system 100. For example, as seen in FIG. 1, according to certain embodiments, the intraday system 102 can include one or more queue systems 106 that can, for example, be utilized in connection with one or more call centers. Thus, the queue system 106 can include hardware and software utilized in receiving communications in one or more forms from customers, such as, for example, via voice, text, chat, or web-based communications, among others. Further, the queue system 106 can also be configured to at least assist in directing customer communications to the appropriate individuals, teams, groups, or departments, including, for example, to appropriate agents, associates, and/or operators, or, alternatively, to the appropriate automated system. According to at least certain embodiments, the queue system 106 is adapted to address inbound customer communications to the intelligent staff scheduling system 100.

The intraday system 102 can further include, according to certain embodiments, one or more workflow systems 108. The workflow system 108 can be involved in working with existing customers and/or customers whose calls were directed to the workflow system 108. For example, according to certain embodiments, the workflow system 108 can be utilized with customers having existing accounts and/or with other insurance related claims. Moreover, in an insurance context, the workflow system 108 could involve activities being performed by agents of an insurance company in connection with an individual, residential or commercial policy holder, including, for example work being performed by an agent in association with an insurance claim(s).

Activities being performed via use of the queue system 106 and/or the workflow system 108 can be monitored in a variety of different manners. For example, according to the illustrated embodiment, an application program interface (API) or webhook (collectively API) 110 can be utilized to obtain data or other information from the either or both of the queue system 106 and/or the workflow system 108 and provide such information to a service level monitor computing device 116. According to certain embodiments, the API 110 can be software or application that can obtain data from, for example, one or more software components, operating systems, and/or servers, among other components, of the queue system 106 and/or the workflow system 108. For example, according to certain embodiments, the API 110 can obtain information or service metrics from the queue system 106 relating to one or more of the number inbound customer calls that are received, placed on hold, the average wait time for inbound callers to speak to an operator, associate, and/or agent, and/or the number of calls being answered within a certain time period, among other information or metrics. Further, with respect to the workflow systems 108, such information or metrics obtained via the API 110 can relate to the duration of time before a customer speaks with a claims specialist or associate, number of contacts between the associate and customer before a claim decision is rendered, and/or a duration of time for a customer to receive money from an insurance claim, among other metrics.

The intraday system 102 can also include a weather event computing device 112 that can include a processor 114. The weather event computing device 112 can be adapted to detect and/or receive information regarding forecasted or actual weather events. Alternatively, or additionally, according to certain embodiments, rather than utilizing the weather event computing device 112, weather event information can be provided to, and/or retrieved by, the intraday system 102 via an application or through use of software, including, for example, via information that is accessed and/or retrieved via use of a network 120. Further, according to certain embodiments, weather event information can be provided, and/or available to, the intraday system 102, via one or more signals from a third party, such as, for example, a weather monitoring and/or reporting service. Additionally, as seen in FIG. 1, according to certain embodiments, weather event information can be communicated, or otherwise retrieved, via use of the API 110.

The weather event information can provide an indication of the actual weather and/or predicted weather forecasts for one or more geographical regions. Moreover, according to certain embodiments, the weather information can relate to the actual and predicted weather at least at locations at which customers are located, and/or areas or locations at which weather can be anticipated to impact the weather conditions at which customers are located. Additionally, according to certain embodiments, the weather event information can also provide retrievable historical weather information. Further, according to certain embodiments, the weather event computing device 112 can receive and/or detect weather information that relates to potentially damaging or significant weather, also referred to as weather events, such as, for example, weather events that can be associated with relatively high winds, hail, lightning storms, tornadoes, hurricanes, heavy rain, floods, freezing rain, and/or blizzards, among other potential relatively significant or damaging weather events.

Further, according to certain embodiments, the weather information obtained and/or received by the weather event computing device 112 can include alerts or other identifiers that can indicate the actual or forecasted occurrence of a weather event, including actual or predicted characteristics of the weather event. The type of at least some of the identified characteristics of the weather event can be based on the type of weather event. For example, in situations in which a weather event relates to a forecasted occurrence of heavy rain, the communicated event characteristics can include anticipated rain fall rates; for each different, or range, of rain fall rates; the timing and durations of the rain fall; current and anticipated ground moisture content or percentage; wind speeds and directions; and/or, water levels for bodies of water in rain fall areas, among other information. Similarly, with respect to hail, such characteristics can include the anticipated timing and duration of the hail event; anticipated size(s) of hail; and/or wind speeds and direction, among other information. Thus, identified characteristics of the weather event can include information that can at least assist in providing an indication of possible damage that may be incurred by the weather event and/or an indication of the severity of the weather event.

The actual or predicted characteristics can further include a location, including a region or other geographic area that is, or is forecasted, to receive or otherwise be impacted by the trigger condition. For example, the characteristics can include one or more geographical areas or regions that are forecasted or predicted to receive a weather event, such as, for example, a relatively heavily rain and/or areas that may have flooding issues in connection with such rain fall. Additionally, the characteristics can also include an indication of the number of customers that are to be impacted by the trigger condition. For example, with respect to weather events and the insurance industry, the characteristics of the trigger condition can include a number of policy holders, or policies in force (PIFs), that are within the area(s) that the trigger condition is anticipated to occur and/or are within the area(s) that is/are forecasted to be impacted by the trigger condition.

Information or metrics relating to the operation of at least portions of the intraday system 102 as well as actual and predicted weather information can be provided to the service level monitor computing device 116, which can include a processor 118. The service level monitor computing device 116 can be configured to evaluate the information or metrics received from at least the API 110 to determine whether certain predetermined thresholds are being satisfied. For example, according to certain embodiments, the predetermined thresholds can relate to service quality thresholds associated with the queue system 106. As previously mentioned, such thresholds can relate to whether hold or wait times for inbound customer calls, and/or the volume of calls being answered within a certain time period satisfy a service level threshold(s), or, alternatively, exceed the service level threshold(s). Exceeding such a service level threshold(s) can, for example, provide an indication that current staffing is experiencing an increase or overload in inbound call levels, or that current staffing levels are insufficient to satisfactorily meet customer volume or demands. In the event the service level monitor computing device 116 identifies a service issue, such as, for example, that a service level threshold is being exceeded, the service level monitor computing device 116 can generate a signal, such as, for example, an alarm signal, that can alert the scheduling management system 104 of an actual or potential staffing and/or work volume or load issue.

Similarly, with respect to workflow systems 108, the service level monitor computing device 116 can be utilized in connection with evaluating whether predetermined service levels or goals are being achieved. For example, the service level monitor computing device 116 can be utilized in evaluating, with respect to a predetermined threshold, the duration of time before completion of a certain task and/or step in a workflow process. Thus, with respect to the insurance industry, such an evaluation by the service level monitor computing device 116 can involve determining whether the duration of time that past before a predetermined milestone achievement or step was achieved in connection with processing or investigating an insurance claim satisfied a threshold duration or goal. Failure to satisfy such a threshold can indicate, among other things, a potential need for a change in staffing levels in a particular associated workflow area. Thus, in the event the service level monitor computing device 116 identifies a workflow issue, the service level monitor computing device 116 can generate a signal, such as, for example, the previously mentioned alarm signal, that can alert the scheduling management system 104 of an actual or potential workflow issue that could relate to staffing levels and/or work volumes.

Additionally, information regarding a weather event, and the associated characteristics, can be provided to the service level monitor computing device 116. Using such information, the service level monitor computing device 116 can determine whether such an actual or forecasted weather event may be of the level that could potential increase a work volume to a degree or level that reallocation of staffing may be warranted. For example, the service level monitor computing device 116 may identify that, based on the actual or forecasted type of weather event, such as, for example, whether the weather event types relates to the occurrence of a tornado or hurricane, among others, may warrant further investigation of potential adjustments, if any, in staffing needs. Additionally, the service level monitor computing device 116 can evaluate, for example, whether one or more actual or forecasted characteristics of the weather event exceed certain predetermined thresholds, such as, for example, wind speeds, rain fall amounts and/or rates, hail size and/or duration, among other characteristics, may warrant further investigation of potential adjustments, if any, in staffing needs. Thus, in the event the service level monitor computing device 116 identifies, or is otherwise informed of, an actual weather event, and/or a predicted weather event, the service level monitor computing device 116 can generate a signal, such as, for example, the previously mentioned alarm signal, that can alert the scheduling management system 104 of the actual and/or forecasted weather event.

The communication of information and/or data between the intraday system 102 and the scheduling management system 104, including communication of an alarm signal(s) that is generated by the service level monitor computing device 116, can occur in a variety of different manners. For example, as seen in FIG. 1, data can be streamed between the intraday system 102 and the scheduling management system 104, including between components thereof, via a network 120. The network 120 can include one or more networks, such as the Internet. In some embodiments of the present disclosure, network 120 can include one or more wide area networks (WAN) or local area networks (LAN). Further, the network 120 can utilize one or more network technologies such as Ethernet, Fast Ethernet, Gigabit Ethernet, virtual private network (VPN), remote VPN access, a variant of IEEE 802.11 standard such as Wi-Fi, and the like. Communication over the network 120 can take place using one or more network communication protocols including reliable streaming protocols such as transmission control protocol (TCP). Further, according to certain embodiments, each of at least the service level monitor computing device 116 and the weather event computing device 112 can interface with at least an intelligent staffing computing device 122 of the scheduling management system 104, among other components of the scheduling management system 104, via the network 120 through the API 110, a web interface and/or any other type of interface that will be apparent from those skilled in the relevant art(s) without departing from the spirit and scope of the present disclosure. These examples are illustrative and not intended to limit the present disclosure.

According to certain embodiments, the scheduling management system 104 can include, in addition to the intelligent staffing computing device 122, a weather database 124, a historical schedule/workload database 126, a current queue/handle time database 130, a neural network 130, a communication unit 132, and an output device 140. The weather database 124 can include a record or data of characteristics relating to a plurality of actual weather events that previously had occurred. The information or data can pertain to at least the types of weather events and associated characteristics that were discussed above with respect to the weather event computing device 112. Thus, for example, information stored in the weather database 124 can relate to types of individual weather events that can be associated with potentially damaging commercial and/or residential property and/or structures, among other potential damage, including, but not limited to, relatively high winds, hail, lightning storms, tornadoes, hurricanes, heavy rain, floods, freezing rain, and/or blizzards, among other potential relatively significant or damaging weather events. While, for different types of weather events, the weather database 124 can include some common types of information relating to the characteristics of the weather events, such as, for example, temperature, wind speed, and/or wind direction, among others, the weather database 124 can also include least some different recorded or stored characteristics that may be relevant for some types of weather events, and irrelevant for others. For example, unlike the type of characteristic information stored relating to weather events involving snow blizzards, information stored in the weather database 124 relating to drought events may or may not include data regarding total snow accumulation.

The weather database 124 can also be generally continuously updated in terms of new or additional information. For example, upon the occurrence of a weather event, details regarding the weather event can be added to the weather database 124. Such details can include, for example, the type and characteristics of the weather event, as discussed above, as well as the location, date, duration, staring time, ending time, and/or season in which the weather event occurred, among other information regarding the identified weather event and the associated properties/characteristics of the weather event. Additionally, according to certain embodiments, the weather database 124 can include data regarding the forecasted characteristics of the weather event, and/or information providing an indication of a variance(s), if any, between the forecasted characteristics and the actual characteristics, which may have been subsequently measured, recorded, and/or observed.

While the foregoing is discussed in terms of a weather database 124, other applications or uses of the embodiments discussed herein can utilize information or data from other historical trigger conditions. Moreover, in addition, or as an alternative, to a weather database 124, the system 104 can include a database that relates to other events that can trigger a change in work load or volume that may necessitate a reevaluation, adjustment, and/or reallocation of staffing. For example, the database can include historical information relating to communication, announcements, and/or occurrence of other types of events, including, for example, concerts, appearances, rallies, conventions, shortages in supplies of particular items, natural and/or man-made catastrophic events, and/or product giveaways, among other events.

The historical schedule/workload database 126 (“historical database”), can include historical information relating to the queue system 106 and/or workflow system 108, among other operations and activities of the associated company, business, industry, and/or entity(ies). Moreover, the historical database 126 can include information relating to the prior staffing scheduled, staffing needs, and/or changes in staffing that can be correlated to a particular trigger condition, such as, for example, to a particular weather event that is recorded in the weather database 124. Such information can also indicate if the staffing utilized in connection with the prior trigger condition, such as, for example, weather event, was, or was not, sufficient, such as, for example in terms of service levels.

For example, the weather database 124 can include information regarding a particular weather event, such as a particular heavy rain event that was associated with the flooding of a particular area. For that particular weather event, the historical database 126 can include information regarding a work volume increase that was actually experienced, such as, for example, the number of additional work hours that were attributed to the occurrence of the weather event. Such work hours can also be segmented into time intervals, such as, for example, an increase of X % for day one, Y % for day two, Z % for day three, etc., where X, Y, and Z are each numerical values that may, or may not, be the same or different from each other. The historical database 126 can also include an indication of the service level that was associated with the staffing levels that were utilized during the weather event. Again, such service levels can be determined in a variety of different manners. According to certain embodiments in which the staffing relates to workers in a call center, such service levels can, for example, be based at least in part on a one or more of the number inbound customer calls that are, or are being placed on, hold, the average wait time for inbound callers to speak to an operator, associate, and/or agent, among other information or metrics, and/or the number of calls that are being answered within a certain time period, among other information or metrics. Further, with respect to the workflow systems 108, such service level determinations can relate, at least in part, to the duration of time before a customer speaks with a claims specialist, number of contacts between the associate and customer before a claim decision is rendered, and/or a duration of time for a customer to receive money from an insurance claim, among other metrics.

With respect to the current queue/handle time database (“current database”) 128, the current database 128 can maintain a record or data of current, or relatively current, operations by the intraday system 102. Moreover, the current database 128 can maintain records or data from the queue systems 106 and/or workflow systems 108 for one or more relatively recent time periods so as to provide an indication of what is currently being, or has relatively recently been, seen or experienced by the queue and/or workflow systems 106, 108 of the intraday system 102. Thus, for example, according to certain embodiments, the data or information maintained by the current database 128 can pertain to information that has been, and/or is being, generated the course of a current work day and/or current work period. Similarly, the data or information can be obtained over one or more work shift(s) that may occur during the course of a work day and/or during the last 24 hours, among other time periods or intervals. Further, information in the current queue can generally be continuously updated, and/or updated at selected intervals, such as, for example, in one hour increments, among other intervals. The timing of data and information maintained by the current database 128 can indicate whether one or both of the queue system 106 and the workflow systems 108 are experiencing an increase in work load or volume and/or a decrease in service level that may warrant an inquiry as to whether staffing changes and a reallocation of work staff is warranted.

From example, the current database 128 can maintain a record of call volumes, wait times, and/or hold times, among other data, associated with the inbound calls the queue system 106 is currently receiving and/or has received during one or more relatively recent time periods or intervals. Such current information can provide an indication of the occurrence or existence of a trigger condition that may necessitate a change in staffing level and/or a reallocation of staff to address an apparent change in work load. Additionally, or alternatively, such a change in current work load can provide an indication that staffing levels may need to be reevaluated and/or adjusted for certain downstream services. For example, data or information indicating a level of detected increase in inbound call volume from residential and/or commercial customers at a call center of an insurance agency can indicate an upcoming increase in work load for agents of the company that are involved processing and/or investigating insurance claims.

Similarly, the current database 128 can also maintain a record or data pertaining to workflow information, as obtained from the workflow systems 108. Such information can include, for example, information regarding the timeliness of the work being performed and/or duration of time before completion of work tasks by agents, associates, and/or other employees of an entity during one or more relatively recent time periods or intervals. For example, in the context of the intelligent staff scheduling system 100 being used by an insurance company, the current database 128 can include data regarding the duration of time from receipt of an inbound call from a customer until a claim investigator of has initial telephonic contact with the customer and/or schedules a time for a property damage investigation, among other types of data.

The weather database 124, historical database 126, and/or the current database 128, among other databases and sources of information or data, can relatively continuously received additional updated data. Thus, over time, as such data is accumulated by scheduling management system 104 continues to increase, the neural network 130 can utilized such data or information in the development and/or refinement of an ad hoc model of the neural network 130. According to certain embodiments, the accumulated, or inputted, data or information from at least the databases 124, 126, 128 can be used by the neural network 130 in connection with training and/or for machine based learning of the neural network 130. Moreover, information from the databases 124, 126, 128 can be used by the neural network 130 in connection with a trigger pattern analysis that can seek to determine patterns or relationships between trigger events, and/or characteristics of trigger events, and the associated work load or changes in work load that may be experienced, including for example the work load experienced at the intraday system 102. Such analysis can assist the neural network 130 in developing and/or refining an ad hoc model that can provide a work load prediction over one or more time periods associated with a predicted, forecasted, and/or detected trigger condition. Moreover, the neural network 130 can apply such data and information to one or more ad hoc models, and, moreover, one or more neural network algorithms, such as but not limited to a multilayer perceptron (MLP), a restricted Boltzmann Machine (RBM), a convolution neural network (CNN), and/or any other neural network algorithm that will be apparent to those skilled in the relevant art(s) without departing from the spirit and scope of the disclosure.

Using an ad hoc model that may be developed and/or refined via at least information from the weather database 124, historical database 126, and/or current database 128, the neural network 130 can use predicted, forecasted, or actual information or data regarding a trigger condition to assist the intelligent staffing computing device 122, in real-time, by providing the intelligent staffing computing device 122 with a relatively accurate prediction(s) relating to the work load and/or staffing needs that may be associated with the occurrence of the trigger condition. For example, according to certain embodiments, such a prediction can be in the form of anticipated work hours needed to address a change in current or expected work volume that may occur upon and/or following the occurrence of a trigger condition, including anticipated work hours for particular individuals, groups, teams, departments, and/or work tasks. Such predications can also provide an indication to the intelligent staffing computing device 122 of, or be used by the intelligent staffing computing device 122 to determine, potential needs for changes in staffing levels and/or an associated reallocation of staff for different time intervals, such as, for example, for each of a certain number of days and/or hours in responding to the occurrence of the trigger condition.

The neural network 130 can also assist the intelligent staffing computing device 122 in learning the appropriate staffing adjustments and/or staffing reallocations to execute in response to a trigger condition. Moreover, as data and information is compiled by the weather database 124, historical database 126, and/or the current database 128, and/or as actual data or information is obtained, the neural network 130 can use such additional information to identify the accuracy of prior predictions that were made by the neural network 130 using the ad hoc model(s). Such a reevaluation can also include the continued identification, or refinement of identified, patterns and relationships, as previously discussed. Thus, the neural network 130 can provide the intelligent staffing computing device 122 with improved accuracy in automatically adjusting or updating the model(s) and/or algorithm(s) utilized by the neural network 130 for the ad hoc model(s) as the neural network 130 continues to learn with the accumulation of additional data and information.

As also seen in FIG. 1, the neural network 130 can also be provided information regarding the timing at which changes in work load may be occur, and thus when staffing levels may need to be changed. According to certain embodiments, the timing of the predicted work arrival can provide an indication to at least the neural network 130 of when the trigger condition, such as, for example, a weather event, is anticipated to, and/or did, arrive or occur. A relatively fast and accurate identification of not only staffing needs, but also the beginning timing of such needs, which can be provided via information from the predicted work arrival, can maintain and/or enhance the service level provided to customers. Further, by the intelligent staff scheduling system 100 being able to provide a relatively accurate determination of staffing needs, an employer can be able to prevent or minimize the wasteful expenditure of resources that can be associated with premature overstaffing, such as, for example, in terms of the payment of additional salaries and wages, while also potentially avoiding harm to reputation and customer experience that can be attributed to untimely understaffing. Additionally, as discussed below, such a system 100 can, when used in connection with a communication unit 132, provide a means for relatively quickly and accurately, as well as automatically, notifying employees as to changes in their work schedules, as well as changed in such employees tasks, assignments, and/or responsibilities that can be attributed to reallocation of staffing to address a change in work volume or level that is attributable to the trigger condition.

The staffing predictions provided by the neural network 130 can also include, for example, a reallocation of staff to satisfy an anticipated change in work volume or load. As indicated by FIG. 1, such reallocation can be guided at least in part by certain rules and/or constraints that can assist in guiding determinations as to which individuals, groups, and/or teams can, and/or cannot, be reallocated to assist with the anticipated change in work volume or load. Such rules and constraints can, for example, be configured to identify the individuals or groups who may be suited to not only address the amount of change, such as, for example, increase, in work load, but also may suited, such as, for example, trained, to perform work tasks associated with the particular trigger condition that has, or is anticipated to cause the work load change. For example, in certain instances, a forecasted weather event, such as, for example heavy rains, may result in the neural network 130 determining, via use of the neural network algorithm, a predicted increase in work load. The neural network 130 can further determine which staff are to be reallocated to assist in handling an anticipated increase in work load.

In making a reallocation determination, the neural network 130 and/or the neural network algorithm can be guided, at least in part, by rules and constraints. For example, such rules and constraints can include prioritizing reallocating individuals and/or teams that have particular experience and/or training dealing with the particular trigger condition. Therefore, individuals or teams having prior experience with, or training relating to, the type of trigger condition that is forecasted to occur, and/or has been detected as occurring, can be prioritized for reallocation over individuals or teams that have lack such experience or training. Additionally, or alternatively, the rules and constraints can also base reallocation decisions at least in part on the tasks or activities the individuals or teams that are subject to potential reallocation are currently scheduled to perform during the time of the anticipated increase in work load. For example, a reallocation rule(s) can emphasis reallocation of individuals or teams scheduled for training exercises or group meetings at the time(s) of the anticipated work load increase over individuals who are scheduled to not be working at that those time(s). Such prioritization may be directed to addressing an anticipated increase in work load while minimizing an increase in additional wages or salaries that may be paid in connection with the anticipated increase in work load. According to other embodiments, such reallocation rules and constraints can relate to reallocating individuals or teams from work groups that are not anticipated to experience a change, or are anticipated to experience a decrease, in work load to work groups or teams are be anticipated to have higher levels of increased work load in response to the trigger condition.

The intelligent staffing computing device 122 can include a processor 134 and a memory device 136. As discussed above, according to certain embodiments, in response to the forecasting and/or detection of a trigger condition, the neural network 130 can provide an indication for the intelligent staffing computing device 122 of an anticipated work load, and/or an anticipated increase in work volume above a base work load, as provided via the base model. Such information can be provided in a variety of formats, including, for example, a number of total or additional work hours that is anticipated to occur as a result of the occurrence of the trigger condition. Additionally, such information can be segmented into time intervals, including, for example, hours, days, and/or weeks, among others, upon and/or after the occurrence of the trigger condition. With such work load information, the intelligent staffing computing device 122 can communicate with a schedule system 138, including, for example a proprietary and/or third party schedule system, to obtain a current work schedule or planned work schedule. As previously discussed, the current or planned work schedule can be based on a base model that is based on an assumption of a number of work hours needed to for a typical work day, or a typical or average work day during the current time of the season. For example, in the insurance industry, the base model can be based on the average number of inbound customer calls that may typically be expected to be received at the current day or season of the year.

The intelligent staffing computing device 122 can use information regarding the anticipated work volume, as provided the neural network 130, and the retrieved work schedule, as provided by the schedule system 138, to determine if changes in the work schedule are needed. Such an evaluation can include determining whether sufficient staffing is currently scheduled to handle the anticipated work load. Such a determination can also include whether a sufficient number of employees are, or are not, scheduled to work, or are available to be reallocated, to help with the teams, departments, and/or tasks that are anticipated to have an increase in work load during one or more time periods as a consequence of the trigger condition. According to certain embodiments, current staffing availability can relate to not just a number of employees, but also the skills and/or experience of the employees to assist in dealing with an increase in work load in one or more specific groups, departments, and/or tasks. Thus, such an evaluation can be based, at least in part, on one or more rules and/or constraints that can relate, for example, to the tasks of the work groups, teams, and/or departments; employee skills, training, experience and/or certification(s), among other credentials; and/or the type of work the employee, group, team, and/or department is/are currently scheduled to perform. Such a determination can by, for example, the intelligent staffing computing device 122, can also be at least partially based at least in part on whether the planned staffing levels can handle the anticipated change, or increase, in work load while providing a predetermined level of customer service level. For example, the evaluation of whether scheduled staffing levels should be increased, and to what degree, can be based at least in part on the level of staffing anticipated to be needed to, in response to the anticipated work load increase, answer the anticipated volume of inbound calls within a certain number of rings, limit wait times for the calls that are placed on hold to certain time duration, and/or an overall time threshold for responding to the corresponding customer requests, among other service level considerations.

If the intelligent staffing computing device 122 determines a sufficient number of employees are scheduled to work during at least some of the one or more time periods associated with the trigger condition, then no changes in work schedules for those particular time periods may be necessary. However, if an insufficient number of employees are determined to be scheduled to work during at least one of those time periods, including an insufficient number of employees to attain desired levels of customer service, then for those time periods, the intelligent staffing computing device 122 may make decisions as to work schedule changes to address the predicted increased work load. Such determinations can be based, at least in part, on the rules and constraints similar to those discussed above with respect to the neural network 130. Thus, for example, the intelligent staffing computing device 122 can determine whether workers, teams, and/or groups in other departments are qualified to assist with the increased work volume. Such determinations can made on an individual, team, and/or department levels, and can include analysis of the skills, training, experience and/or certification(s) of individual employees or groups of employees. Other rules and/or constraints can relate to scheduled tasks, which may be prioritized in at least terms of availability to assist with the increased work load. For example, as discussed above, the rules and/or constraints can establish that employees or groups scheduled to be in training during the expected increase in work load are to be deemed available for reassignment to assist in with the increased work load over employees or groups that are scheduled to perform other tasks, and/or over employees that are not currently scheduled to work during those time periods.

In view of the foregoing, according to certain embodiments, the rules and/or constraints evaluated by the intelligent staffing computing device 122 can be prerequisites that are each to be satisfied if an employee, or groups or teams of employees are to be considered to be available to assist with a predicted increase in work load. Alternatively, whether an employee currently scheduled to work is to be considered available for purposes of assisting with a predicted increase in work load can be based on a scoring system, wherein a weighted value may be placed on, or within, certain rules and/or constraints. Thus, according to certain embodiments, skill level and/or experience of an individual, team, and/or department, may be given a higher weighted value than the type of task that the individual, team, and/or department would be removed from when being at least temporarily reallocated to perform another task in connection with assisting with the anticipated increase in work load. Thus, availability for reallocation can be based on a cumulative score satisfying a particular numerical threshold.

According to certain embodiments, the intelligent staffing computing device 122 can include, or be communicatively coupled to, a communication unit 132. The communication unit 132 can be a wired or wireless system that can communicate changes in work schedule. The communication unit 132 can be configured for wired and/or wireless communications between the intelligent staffing computing device 122 and other portions of the system 100, including for example an output device 140. Such wireless communications can occur using proprietary and/or non-proprietary wireless communication protocols, including, but not limited to, Wi-Fi, ZigBee, Bluetooth, radio, or near-field communications, among other communication protocols. According to certain embodiments, the communication unit 132 can each comprise a transceiver. A variety of different types of devices can be utilized as the output device 140, including, for example, devices that utilize a screen or display. For example, according to certain embodiments, the communication unit 132 can be utilized to communicate information regarding work schedules, including, for example, changes to work schedules, to employee output devices 140, such as, for example, to a client device, including, but not limited to, mobile phones, smart devices, and/or lap tops, among other personal computing devices. Thus, such communications can be received, for example, a text message, email, and/or automated call, among other forms of messaging and communication.

As seen in FIG. 1, the neural network 130 can include, or be communicatively coupled to, a trigger history log 142 that may maintain information similar to that previously discussed with respect to the weather database 124 and/or historical database 126. According to certain embodiments, the trigger log 142 can provide a record of actual characteristics of one or more trigger conditions, such as, for example weather events, including, for each weather event, the actual change, if any, in work load, the timing for such a work load changes, and/or how the workload changed or varied before, during, and/or after the weather event. The neural network 130 can utilize information, from the trigger log 142, among other information, in connection with performing the previously discussed trigger pattern analysis and/or to improve the accuracy of the work load predictions of the neural network 130. Identification of such patterns can include developing relationships between certain variables that can impact anticipated work loads, which can again be used to determine or adjust staff scheduling needs. For example, with respect to anticipated flooding events, such relationships may help predict staffing levels based on relationships between ground moisture content, ambient temperatures, rainfall amounts, and duration of time between rainfall events. As data regarding such events continues to be obtained and analyzed with respect to other data for identification of patterns and/or relationships, the accuracy of the predictions generated by the neural network 130 may be improved.

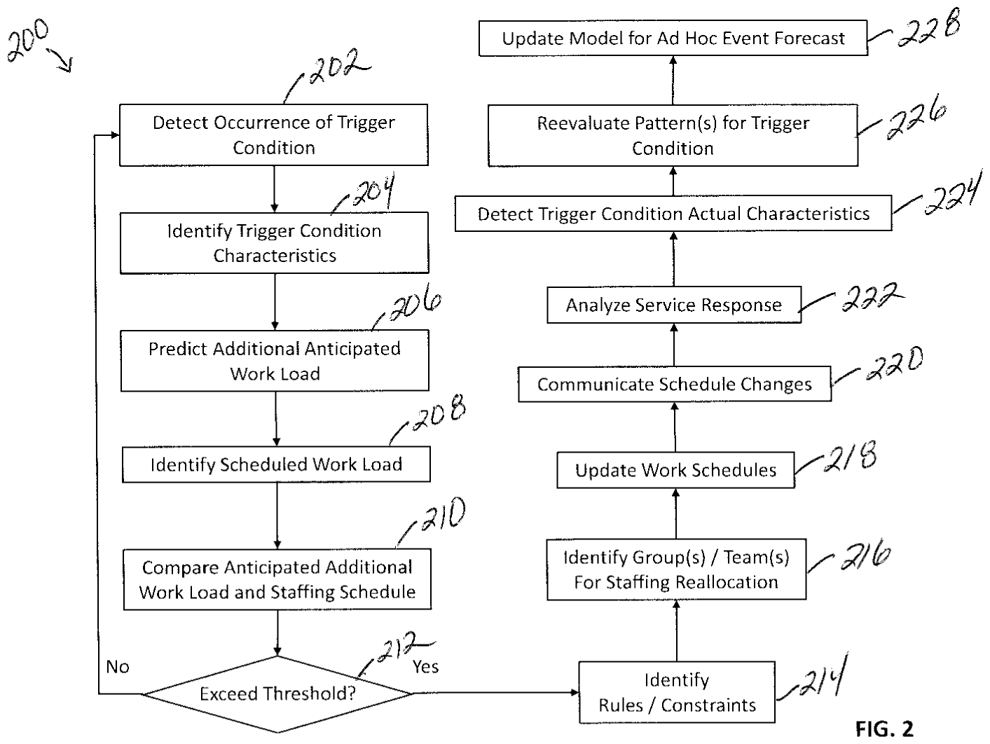

FIG. 2 illustrates a simplified flowchart of a method 200 that can be performed by the intelligent staff scheduling system 100 in connection with reallocating work staff following detection of a trigger condition. The method 200 corresponds to, or is otherwise associated with, performance of the blocks described below in the illustrative sequence of FIG. 2. It should be appreciated, however, that the method 200 can be performed in one or more sequences different from the illustrative sequence.

At block 202, a trigger condition can be detected, such as, for example, by one or more systems of the intraday system 102. As variety of different types of events can provide the trigger condition, the portion of the intraday system 102 that detects, or used to detect, the trigger condition, can be based at least in part of the type of trigger condition. Additionally, the trigger condition can be a predicted or forecasted trigger condition, and thus may not have actually yet occurred. Additionally, or alternatively, the trigger condition can be an actual event that is currently occurring, or has already occurred.

For example, with respect to use of the method in the insurance industry, the trigger condition can be a forecasted event, such as, for example, a weather event that has not yet occurred, but is predicted to be occurring within a certain time period. Additionally, or alternatively, the trigger condition could be an occurrence that has already happened, such as, for example, flooding associated with a break in a damn or levy, among other types of events. In such situations, the weather event computing device 112 of the intraday system 102 can be used to detect the trigger condition. Further, the manner in which the trigger condition is detected can vary. For example, the trigger condition can be detected via a receipt by the weather event computing device 112 of a weather alert from a weather service, an automated or computer generated weather forecast having certain abnormal characteristics and/or values that are outside one or more thresholds, and/or of news or information from a news source. Additionally, or alternatively, the trigger condition can be detected via the service level monitor computing device 116 detecting that service level or quality is outside one or more thresholds. Alternatively, the trigger condition can be a sudden rise in call volume and/or hold time in a call center, among other events, which can be detected, for example, via the queue system 106, workflow system 108, and/or service level monitor computing device 116.

At block 204, one or more characteristics associated with the trigger condition can be identified, detected, and/or received, such as, for example, via used of the intraday system 102. The particular characteristics of the trigger condition that are identified, as well as which portion of the intraday system 102 is utilized, can be at least partially dependent on the type of trigger condition. For example, trigger conditions relating to weather events can include one or more characteristics that may be germane to the weather event, and/or may be outside of certain thresholds that may indicate the weather event could be potentially damaging. For example, with respect to weather events relating to forecasted high winds, the processor 114 of the weather event computing device 112 can be utilized to identify characteristics relating to anticipated wind speeds, anticipated wind directions, anticipated arrival time of the weather event, anticipated duration of high wing event(s), and/or geographical locations anticipated to experience the high wind conditions, among other information. According to certain embodiments, such information regarding the trigger condition and the identified characteristics can be obtained from the weather event computing device 112 by the API 110 and communicated via the network 120 to the scheduling management system 104, including, for example, to the neural network 130. With respect to the queue system 106, workflow system, 108, and/or service level computing device 116, such characteristics can generally relate to call volume, rate of inbound calls, call hold time, call wait time, response times, and/or times to perform certain tasks, among other metrics.

At block 206, the neural network 130 can apply information regarding the trigger condition, such as the trigger characteristics from block 204, with the ad hoc model or neural network algorithm to predict a work load that may be associated with the occurrence of the trigger condition. Again, the predicted work load can be expressed in a variety of forms, including, for example, provided in terms of anticipated work hours, as well as the timing of such anticipated work hours. Further, as discussed above, the predicted work volume can be provided on an individual, team, group, department, and/or task level. For example, the algorithm can provide a prediction of work load associated with the trigger condition for each of one or more work teams, groups, departments, and/or tasks during a plurality of time periods upon and/or after occurrence of the trigger condition. The time periods can be expressed in a number of time intervals, including, for example, in terms of quarters hours, half hours, hours, days, and/or weeks, among others, as well as combination thereof.

At block 208, one or more current work schedules can be obtained for evaluation with the predicted work load at block 210. For example, according to certain embodiments, at block 208 the processor 134 of the intelligent staffing computing device 122 can be utilized to obtain one or more current work schedules from the schedule system 138. The information from the retrieved work schedules can provide information with respect to particular work teams, groups, departments, and/or tasks. At block 210, the processor 134 of the intelligent staffing computing device 122 can compare information regarding the predicted work load, as provided by the neural network 130, with information from the retrieved current work schedule(s) to determine if, the currently scheduled work teams, groups, departments, and/or tasks are sufficiently staffed to handle the predicted work load. As indicated by block 212 in FIG. 2, such a comparison can include determining, using the processor 134 of the intelligent staffing computing device 122, whether differences between the work load prediction and the current work schedule exceeds a threshold value. Such a threshold value can include, for example, a difference in the number of predicted work hours for a work team, group, department and/or tasks, as indicated by the neural network 130, and the number of work hours currently scheduled for that work team, group, department and/or tasks. In such an embodiment, if the threshold is not exceeded, then the method can return to block 202, and await detection of another trigger condition.

If the threshold is determined at block 212 to be exceeded, then at block 214, the processor 134 of the intelligent staffing computing device 122 can identify or retrieve rules and/or constraints that can assist in guiding determinations as to which individuals, groups, and/or teams are to be reallocated to assist with the anticipated change in work volume or load. Similar to the rules and constraints discussed above with respect to FIG. 1, such rules and constraints can, for example, be configured to identify the individuals or groups who may be suited to not only address the amount of change in work load, but also may suited, such as, for example, trained, to perform work tasks associated with the particular trigger condition that has, or is anticipated to cause the work load change.

Using the identified rules and/or constraints, at block 216 the processor 134 of the intelligent staffing computing device 122 can identify individuals, teams, groups, and/or departments that are to be reallocated, and/or be scheduled to work, to address the predicted change in work load. Such changes in work schedules can be provided to the schedule system 138 from the intelligent staffing computing device 122 at block 218, and be communicated, such as, for example, via the communication unit 132, to employees, including, for example, to output devices 140 of the employees, at block 220.

The accuracy of the work load prediction from the neural network 130, including the adequacy of adjustments in work schedules, can be based at least in part on information obtained during, and/or after, the trigger condition. Such an evaluation, which can be performed in a variety of manners, can indicate whether, based on the ad hoc model, too few or too many works were reallocated and/or assigned to assist in dealing with the predicted work load. For example, the adequacy of the changes in the work schedules, including changes based on reallocation of employees and/or increasing staffing, can be determined at block 222 via analyzing service response times of the teams, groups, and/or departments that were anticipated to experience a change in work load in response to the trigger condition. Such an analysis can include identifying the actual change in work load that occurred in response to the trigger condition. Further, such an analysis can include comparing the predicted and actual workloads associated with the trigger condition and/or differences between the actual and predicted work hours that occurred. Thus, for example, in the context of at least the insurance industry, the adequacy of such scheduling adjustments can be evaluated based on wait and hold times for inbound calls, as may be detected via use of the processor 118 of the service level monitor computing device 116. Additionally, with respect to reallocation and/or assignments to assist with a predicted increase in work load for a work load system, the adequacy of such scheduling adjustments can be evaluated, for example, based on the time for an agent or representative to contact a customer, and/or a time for a the agent or representative to perform one or more predetermined actions, as may be detected via use of the processor 118 of the service level monitor computing device 116.

While at block 204 the characteristics of the trigger condition may be forecasted or predicted characteristics, at block 224 the actual characteristics of the trigger condition can be detected and/or recorded. Such detection and/or recording of the actual characteristics of the trigger condition can occur during a variety of times during the method 200. Thus, for example, with respect to a trigger condition relating to a weather event, the actual characteristics of the weather event can be detected and recorded throughout the weather event. The types of characteristics actually detected can be based at least in part on the type of weather event. For example, with respect to flooding events, the actual characteristics detected or corrected can include rail fall amounts, duration of rain falls, time between different rain falls, lake levels, wind speeds, and/or wind directions, among other characteristics of the trigger condition.

Using information regarding the trigger condition that was detected at block 202, as well as historical information regarding prior similar trigger conditions, the neural network 130 at block 226 can perform a trigger pattern analysis. As previously discussed, the trigger pattern analysis can be used to identify, and/or refine already identified, patterns or relationships between the trigger condition, and/or associated characteristics of the trigger condition, and the associated work load. Moreover, such patterns or relationships can be developed or refined in connection with determining how such trigger conditions, and/or associated characteristics of the trigger condition, impact work loads and staffing needs. Thus, to the extent such patterns and/or relationships were previously developed using other historical information, the additional information obtained relating to the most recent trigger condition, such as the trigger condition detected at block 202, can be utilized to in connection with determining of the already identified patterns and/or relationships are to be changed or adjusted. Further, such changes, if any, in determined patterns or relationships can then result in a similar updating at block 228 of the ad hoc model, and, moreover, the algorithm utilized by the neural network 130 for future determinations of workloads for future trigger conditions.

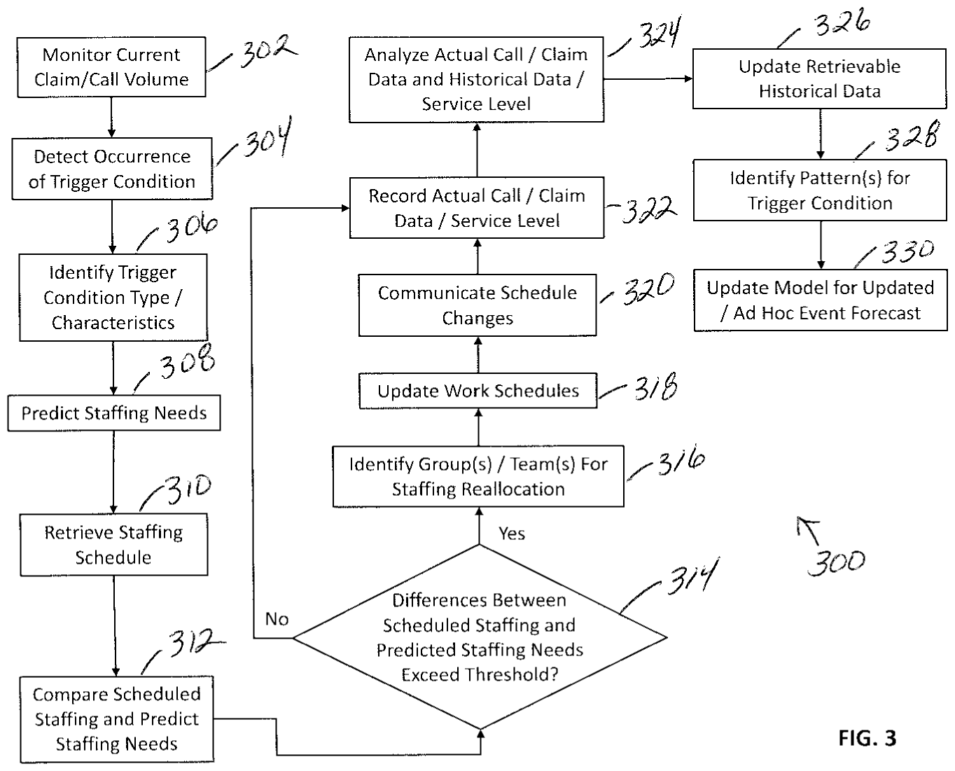

FIG. 3 illustrates a simplified flowchart of a method 300 that can be performed by the intelligent staff scheduling system 100 in connection with reallocating work staff in a call and/or claim center in response to the occurrence of a trigger condition. The method 300 corresponds to, or is otherwise associated with, performance of the blocks described below in the illustrative sequence of FIG. 3. It should be appreciated, however, that the method 300 can be performed in one or more sequences different from the illustrative sequence.

At block 302, the current claim or call volume can be monitored, such as, for example, by the workflow system 108 and queue system 106, respectively. Further, such information can be recorded by the current database 128. At block 304, a trigger condition can be detected. The trigger condition can, according to certain embodiments, relate to non-compliance with a threshold value. For example, with respect to at least the queue system 106, the trigger condition can relate to a time or number or rings before inbound customer calls are answered, and/or to a duration of time that callers are waiting on hold before being able to speak to an appropriate agent or associate, exceeding an associated predetermined threshold value. Additionally, or alternatively, the trigger condition can relate to a period of time before an action is performed, or completed, by an agent or associated exceeding an associated predetermined threshold value. According to certain embodiments, the processor 118 of the service level monitor computing device may detect the occurrence of the trigger condition. The occurrence of such a trigger condition can be determined utilizing information from the associated queue or workflow system 106, 108, and/or via information from the current database 128.

At block 306, characteristics of the trigger condition can be identified. Such characteristics can include an indication of the overall increase in inbound calls and/or claims, the rate at which such calls and/or claims are being received, and/or response times to such calls and claims. Further, such characteristics can include actual data from the trigger condition, and/or forecasted or predicted characteristics. Such forecasted or predicted characteristics can be based on historical information regarding prior trigger conditions and/or trends seen or experienced with the current trigger condition. According to certain embodiments, information regarding the characteristics of such a trigger condition can be provided via at least the current database 128. Information regarding the trigger condition, including, but not limited to the characteristics from block 306 can be utilized at block 308 by an ad hoc model, such as, for example, a model provided by self-learning algorithm of the neural network 130, to predict a work load that may be associated with the trigger condition. Such a predicted work load can be utilized at block 308 to predict staffing needs for responding to the trigger condition. Again, such a prediction can be provided in a variety of different manners, including, for example, in terms of work hours anticipated to be needed to handle the predicted work load of the trigger condition at one or more time intervals, such as, for example, in terms of hours, days, and/or weeks, among other intervals.

At block 310, an existing staffing schedule can be retrieved, such as, for example, from the schedule system 138, by the intelligent staffing computing device 122. The existing staffing schedule can be a schedule that was developed using a base model, as previously discussed. At block 312, the existing staffing schedule and the staffing needs predicted at step 308 can be compared in connection with evaluating whether the current level of staffing, as indicated by the retrieved staffing schedule, can satisfy the predicted staffing level needs. As previously discussed, such staffing evaluation can be generally limited to scheduled staffing for the department(s), team(s), group(s) and/or tasks that are expected to be impacted by the trigger condition. Further, such a determination can be made, at least in part, with respect to whether the staffing is sufficient to satisfy predetermined service levels, as indicated by block 314. According to certain embodiments, such an evaluation, which can be performed by the processor 134 of the intelligent staffing computing device 122, can include determining whether the predicted staffing needs exceeds the scheduled staffing, as retrieved at block 310, by a predetermined threshold. The predetermined threshold can, as well as other thresholds discussed herein, be based on a variety of different criteria, including, for example, associated work hours and/or number of employees.

If at block 314 a determination is made that the differences between the predicted staffing and the scheduled staffing exceed the predetermined threshold, then, at block 316, the processor 134 of the intelligent staffing computing device 122 can identify groups, teams, departments, and/or individuals that may be available to reallocate, and/or to be added to the work schedule, to assist with handling the predicted work load. Such determinations can again utilize preexisting rules and/or constraints that are at least similar to those discussed above with respect to at least FIG. 1 and block 214 of FIG. 2. Using the information obtained at block 316, at block 318, the processor 134 of the intelligent staffing computing device 122 can update the work scheduled to reflect the reallocation of staff and/or the identified available groups, teams, departments, and/or individuals that are now being scheduled to assist with the increased work volume. Such updates, or changes, in work schedules can be communicated to the schedule system(s) 138, and/or the identified groups, teams, departments, and/or individuals at block 320. Such communication can be similar, at least in part, to the communication discussed above with respect to block 220.

Regardless of whether the differences in the scheduled staffing and predicted staffing needs does, or does not, satisfy a predetermined threshold, as determined at block 314, the data associated with the actual trigger condition can be recorded at block 322. Such recording of actual data regarding the trigger condition can occur at least upon detection of the occurrence of the trigger condition, as detected at block 304, and continue until at least the trigger condition has concluded. The conclusion of the trigger condition can be determined in a variety of manners, and can be based at least in part on the type of trigger condition. For example, with respect to trigger conditions relating to claim and/or call volumes or a level(s) of service, the trigger condition can be considered to have concluded upon the claim and/or call volumes or the associated level(s) of service reaching, or returning, to predetermined, or normally expected levels, and/or returning to such predetermine, or normally expected levels, for a predetermined duration of time. Such predetermined, or normally expected, levels can, according to certain embodiments, be those levels associated with determinations using the above-discussed base model(s).

At block 324, the data associated with the actual trigger condition that was recorded at block 322 can be used to determine the accuracy of the predication that was made at block 308. Thus, for example, at block 324, the accuracy of the anticipated increase in work load and/or associated predicted work hours or staffing that was obtained via use of the ad hoc model can be evaluated. Moreover, the results of such an evaluation can indicate to the neural network 130 whether the ad hoc model and/or associated algorithm utilized by the neural network 130 should be changed or adjusted so as to at least attempt to increase the accuracy of future predictions.

At block 326, the information recorded at block 322 can be stored with other historical information, such as, for example, in the historical database 126 and/or current database 128. The addition of the information obtained at block 322 and similar historical information can be utilized at block 328 in further attempting to identify patterns, and/or refine the identified patterns relating to the work load changes and/or staffing needs associated with similar trigger conditions. Thus, such identification and/or refinement of identified patterns at block 328 can be similar to the process described above with respect to at least block 226 of the method 200 discussed in connection with FIG. 2. Further, similar to block 228, at block 330 such identification and/or refinement of identified patterns can result in an similar updating of the ad hoc model, and, moreover, the algorithm utilized by the neural network 130 for future determinations of workloads associated for at least similar future trigger conditions.

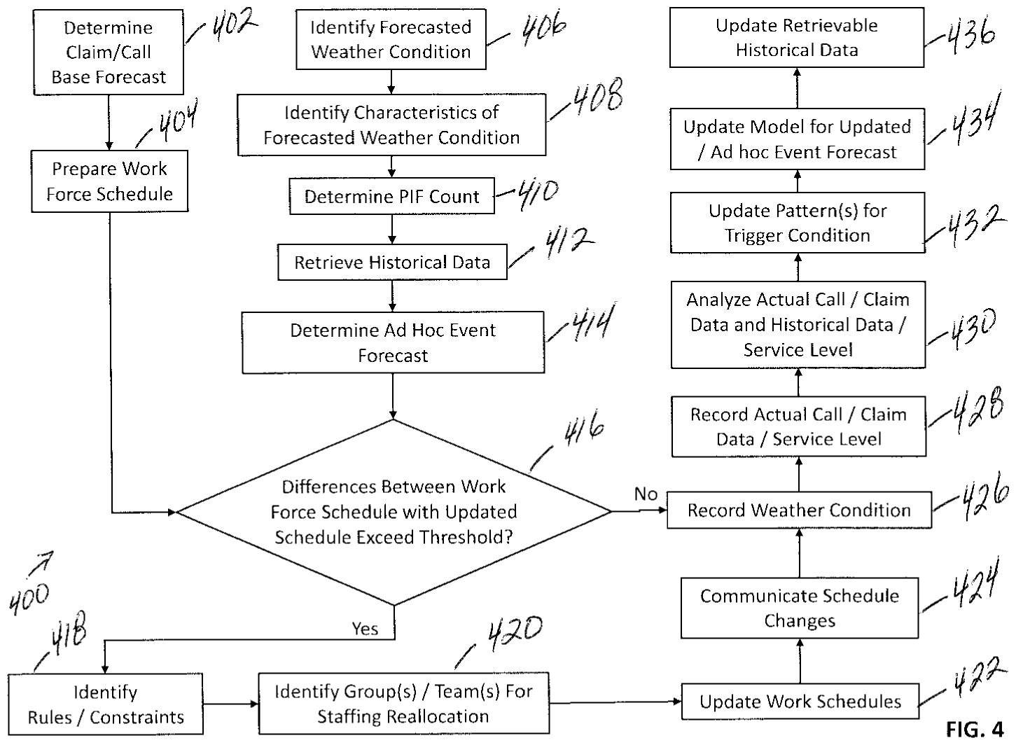

FIG. 4 illustrates a simplified flowchart of a method 400 that can be performed by the staff scheduling system 100 in connection with reallocating work staff in response to a prediction of an upcoming trigger condition in the form of a weather event. The method 400 corresponds to, or is otherwise associated with, performance of the blocks described below in the illustrative sequence of FIG. 4. It should be appreciated, however, that the method 400 can be performed in one or more sequences different from the illustrative sequence.

At block 402, a base model can be utilize to determine an expected work load, work hours, and/or staffing needs that can be anticipated to occur during one or more time periods. Again, the base model can be based on historical information that, absent a trigger condition, corresponds to anticipated workloads during generally normal operating conditions or times. For example, as previously mentioned, a call or claim center can typically be staffed using an outcome from base model that can, for example, be based on how many inbound calls or claims are typically expected to occur during an average working day for the current day of the week and time of year. According to certain embodiments, the base model can be a model applied by the processor 134 of the intelligent staffing computing device 122, and/or obtained from the schedule system 138. Using information from the base model, at block 404, the processor 134 of the intelligent staffing computing device 122 and/or the schedule system 138 can prepare a work force schedule, which can indicate a current and/or future work schedule(s) for employees, teams, groups, and/or departments.

Subsequent to, and/or independent of, blocks 402 and 404, a trigger condition, such as, for example, a forecasted or predicted weather event, can be identified at block 406, and the forecasted or predicted characteristics of the trigger condition can be identified at block 408. Such identification of the predicted trigger condition and associated predicted characteristics at blocks 406 and 408 can be similar to at least the above-discussed predictions relating to blocks 202 and 204, respectively, of the method 200 of FIG. 2. Additionally, at block 410 a policies in force (PIF) count can be determined. Such a PIF count can, for example, be based at least in part on information pertaining to the characteristics that were obtained ay block 408 relating to areas that are anticipated to be impacted by the trigger condition and/or areas at which the trigger condition will be located, as well as an identification of the number of PIFs in that/those identified areas or locations. According to certain embodiments, the PIF count can be determined via use of the processor 134 of the intelligent staffing computing device 122, among other portions of the system 100. Information regarding the PIF count can be utilized by the neural network 130 in connection with predicting the anticipated work load, work hours and/or staffing that may be associated with the occurrence of the trigger condition.

According to certain embodiments, at block 412, historical information relating to similar trigger conditions can be obtained, such as, for example, from the historical database 126. Alternatively, according to other embodiments, such historical information may have previously been used in connection with the self-learning capabilities of the neural network 130, and thus may have already been utilized in the development of the algorithm, or ad hoc model, that is utilized by the neural network 130 for determining workloads associated for such types of trigger conditions.

Utilizing at least the information obtained at blocks 408 and 410, the neural network 130 can use the ad hoc event model, which, again, can be based on a self-learning model(s) or algorithm(s), to predict a work load, work hours, or staffing needs that may be needed in response to the occurrence of the trigger condition. Again, such a model can, according to certain embodiments, be at least partially based on having sufficient staffing to respond to the trigger condition with a predetermined level of customer service, such, as, for example, with respect to the average number of rings before in-bound customer calls are answered and/or customer hold or wait times, among other criteria.

Similar to blocks 212 and 314 of the methods 200, 300 depicted in FIGS. 2 and 3, respectively, at block 416 the outcomes from the base model and the ad hoc model can be compared to determine whether a difference in, or relating to, the outcomes from those models exceeds a predetermined threshold. Such a determination as to whether the predetermined threshold is exceeded can be determined by the processor 134 of the intelligent staffing computing device 122, among other components of the system 100. For example, the work hours associated with the work force schedule that was prepared at block 404 based on the base model can be compared to the work hours predicted to be associated with responding to the trigger condition, as determined via the ad hoc model at block 414. If the predicted work hours surpasses the work hours that are to be provided by the current work schedule by a certain amount, such as, for example, by certain number of hours and/or by a percentage, then the predetermined threshold may be determined to be exceeded, thereby indicating a need for an increase in staffing.

Accordingly, if a determination is made at block 416 that the predetermined threshold is exceeded, then at block 418, and similar to block 214, the processor 134 of the intelligent staffing computing device 122 can identify or retrieve rules and/or constraints that can assist in guiding determinations as to which individuals, groups, and/or teams are to be reallocated to assist with the anticipated change in work volume or load. Further, similar to block 216, at block 420, using the rules and constraints obtained at block 418, the processor 134 of the intelligent staffing computing device 122 can identify individuals, teams, groups, and/or departments that are to be reallocated, and/or be scheduled to work, to address the predicted change in work load. The individuals, teams, groups, and/or departments identified at block 420 can then be scheduled accordingly, and/or have an adjustment in scheduled task(s)/assignment(s), at block 422. Such changes and/or additions in scheduling can be performed using the processor 134 of the intelligent staffing computing device 122 and/or via the schedule system 138. Further, the changes to the work schedule can be communicated at least to the effected workers at block 424. Such communication, which can, according to certain embodiments, occur automatically in response to a schedule change, can be provided in a variety of different manners, including, for example, via the communication unit 132 including, for example, by the communication unit 132 facilitating or providing communications to output device(s) 140 of the employee(s).

Regardless of whether the differences in the scheduled staffing and predicted staffing needs does, or does not, satisfy a predetermined threshold, as determined at block 416, the data associated with the actual trigger condition can be recorded at block 426. Such recording of data can include recording at the weather database 124 data relating to the actual characteristics of the triggering weather event, including recorded and measured data. Further, data can also be recorded relating to the work load or volume experienced as a consequence of the weather event, such as, for example, at the historical database 126. Thus, for example, at block 428, workloads relating to claim and/or call volumes and/or level(s) of customer service achieved, or not achieved, when responding to the weather event can be recorded. Further, the duration of time covered by the recorded data for blocks 426 and 428 can vary. For example, according to certain embodiments, the data recorded at block 426 and/or block 428 can commence with the forecasting of the weather event at block 406. Additionally, the data recorded at block 426 and/or block 428 can commence with the detection of the actual occurrence of the weather event. Further, the recording of data from block 426 and/or block 428 can conclude with the detection of the end of the weather event, and/or upon workloads or volumes returning to levels associated with predictions provided by the base model and/or generally normal workloads or volumes that would generally be anticipated in the absence of the trigger condition.

At block 430, the data obtained at block 430 can be used to determine the accuracy of the predication that was made at block 414. Thus, for example, at block 430, the accuracy of the anticipated increase in work load and/or associated predicted work hours or staffing that was obtained via use of the ad hoc model can be evaluated. The results of such an evaluation can indicate to the neural network 130 whether the ad hoc model(s) and/or associated algorithm(s) utilized by the neural network 130 should be changed or adjusted so as to at least attempt to increase the accuracy of future predictions.

At block 432, the information recorded at block 426 and/or block 430 can be utilized in further attempting to identify patterns, and/or refine the identified patterns relating to the work load changes and/or staffing needs associated with such types of trigger conditions. Thus, such identification and/or refinement of identified patterns at block 432 can be similar to the process described above with respect to at least block 226 of the method 200 discussed in connection with FIG. 2. Further, similar to block 228, at block 434 such identification and/or refinement of identified patterns can result in an similar updating of the ad hoc model, and, moreover, the algorithm utilized by the neural network 130 for future determinations of workloads associated with at least similar types of trigger conditions. Finally, to the extent not already recorded, the information obtained at blocks 426 and 428 can be stored in the weather database 124 and/or historical database at block 436. Such historical information can again be used to modify the ad hoc model and/or assist in future identification of, or refinement in, patterns relating to such types of events that can assist in self-learning by the neural network 130.

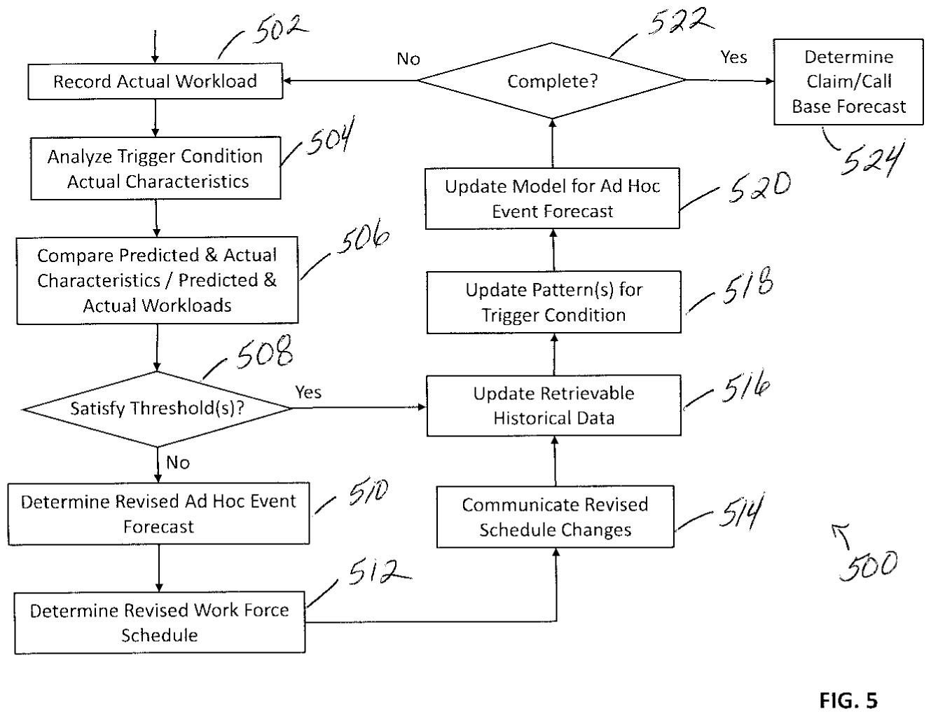

FIG. 5 illustrates a simplified flowchart of a method 500 that can be performed by the intelligent staff scheduling system 100 in connection with adjusting a reallocation of work staff as actual characteristics are identified or measured during a trigger condition. The method 500 corresponds to, or is otherwise associated with, performance of the blocks described below in the illustrative sequence of FIG. 5. It should be appreciated, however, that the method 500 can be performed in one or more sequences different from the illustrative sequence.

According to certain embodiments, including the methods 200, 300, 400 illustrated in FIGS. 2-4, adjustments can be made in staffing assignments and reallocations during the trigger condition. For example, predicted or actual characteristics of the trigger condition can change, including before and/or during the trigger condition. Such changes in the characteristics can necessitate a change in the work scheduled, regardless if the work schedule is based on the base model or was previously adjusted one or more times via use of the ad hoc model of the neural network 130. Thus, the method 500 shown in FIG. 5 can be an iterative process in which recorded data or updated forecasts can be utilized in connection with determining whether prior staffing decisions that were previously made using the base model or the ad hoc model of the neural network 130 should, or should not, be adjusted.

For example, during the occurrence of a trigger condition, and/or while dealing with the resulting impact of a trigger condition, the actual workload being experienced can be recorded at block 502. The type of data recorded at block 502 can depend on the type of work being performed. For example, with respect to inbound calls received by the queue system 106, the queue systems 106 and/or the service level monitor computing device 116 can be utilized to track the number of inbound customer calls received within a certain time period or at certain time intervals, the number of rings before such inbound calls are answered, and/or the wait time before the calls are directed to an employee, associate, and/or agent who is to address the purpose of the call, among other data. Similarly, such data can relate to the service level provided by the queue systems 106, the workflow systems 108, and/or the service level monitor computing device 116.

At block 504, information regarding the actual characteristics of the trigger condition can also be attained. For example, according to embodiments in which the trigger condition is a weather event relating to relatively heavy rain, recorded or measured values relating to the trigger condition can include, but are not limited to, rain fall totals, rain fall rates, wind speeds and directions, water levels, geographic areas impacted, and/or PIF counts impacted by the trigger condition, among other information. Additionally, or alternatively, block 504 can be utilized to provide a current, or updated, prediction of the characteristics of the forecasted trigger condition. The information from block 504 can be obtained and/or recorded by a variety of components of the system 100, including, for example, the weather event computing device 112, and/or via a network connection to an external source using the network and the processor 134 of the intelligent staffing computing device 122.

At block 506, the information obtained at block 502 and/or block 504 can be compared to a prior prediction that was made via use of the neural network 130, including, for example, a prediction that was made at block 206, 308, 414 of FIGS. 2-4, respectively. The type of data utilized for such a comparison can be based, at least in part, on the type of information obtained at block 502 and/or block 504. Further, according to certain embodiments, the comparisons, or other evaluation, performed at block 506 can be performed by the processor 134 of the intelligent staffing computing device 122. Such a comparison can include determining, at block 508, whether the differences, if any, between actual workload experienced associated with the trigger condition, as recorded at block 502, do, or do not, satisfy one or more predetermined thresholds. Such thresholds can be based, at least in part, on whether the actual workload, as recorded at block 502, exceeds, or is below, the anticipated work load by a specific amount or percentage, which can thereby indicate a possibility of understaffing, or, alternatively, an overabundance of staffing. Additionally, the comparison at block 506 can further include evaluating whether the actual or updated predicted characteristics of the trigger condition, such as, for example, a weather event, are more or less severe than previously forecasted or actually measured. Again, the extent or degree of such differences determined at block 506 can, at block 508, be evaluated with respect to one or more predetermined thresholds. Such an evaluation, which, again, can be performed by the intelligent staffing computing device 122, can be utilized to determine if the current staffing schedule is to be adjusted.

If one or more of the predetermined thresholds are determined at block 508 to not be satisfied, then the ad hoc model of the neural network 130 and/or information from block 502 and/or block 504 can be utilized to obtain an updated prediction of the work load or volume that is to be associated with the trigger condition, and/or the work load or volume anticipated to be experienced for the remainder of the duration or impact of the trigger condition. The prediction from block 510 can then be used to determine a revised work schedule at block 512. The determination at block 512 can be performed by the intelligent staffing computing device 122 or schedule system 138, and can, according to certain embodiments, utilize the at least a portion of the approaches discussed above with respect to blocks 208-218 of the method 200 shown in FIG. 2, blocks 310-318 of the method 300 of FIG. 3, and/or blocks 416-422 of the method 400 shown in FIG. 4. Further, similar to blocks 220, 320, and 424, at block 514 changes in work schedules can be communicated to at least the effected workers.

As the ad hoc model of the neural network 130 can comprise a self-learning model(s) or algorithm(s), regardless of whether the thresholds are determined to be satisfied at block 508, at block 516 data from block 504 and/or block 506 can be stored, such as, for example, in the historical database 126 and/or the weather database 124. The neural network 130 can use such data from block 504 and/or block 506, as well as associated data from the historical database 126 and/or weather database 124 to further identify, and/or refine identified, patterns at block 518 in an attempt to improve the accuracy of the ad hoc model. Moreover, as previously discussed, such patterns can assist in further refining, adjusting, or updating the ad hoc model at block 520.

At block 522 a determination can be made as to whether the trigger condition has ended or past, including, for example, whether the impact of the trigger condition has concluded. The conclusion of the trigger condition can be determined in a variety of different manners. For example, according to certain embodiments, the trigger condition can be determined to have concluded at a predetermined time period after the actual occurrence of the trigger condition is detected. Additionally, or alternatively, the trigger condition can be determined to have concluded by the intelligent staffing computing device 122 identifying that work load or volume data, as provided, for example, at block 502, has reached levels consistent with projections provided by the base model, or has reached such levels for a predetermined period of time, thereby indicating a return to generally normal operating conditions. In the event the trigger condition is determined to not be complete, then the method can return to block 502 for further evaluation as to the possible need, if any, to revise the prediction from the neural network 130 based on updated information, and thus further revise the work schedule. However, if the trigger condition is determined to have concluded, then at block 524 a work schedule can again be determined via use of the base model, at least until detection or prediction of the next trigger condition.

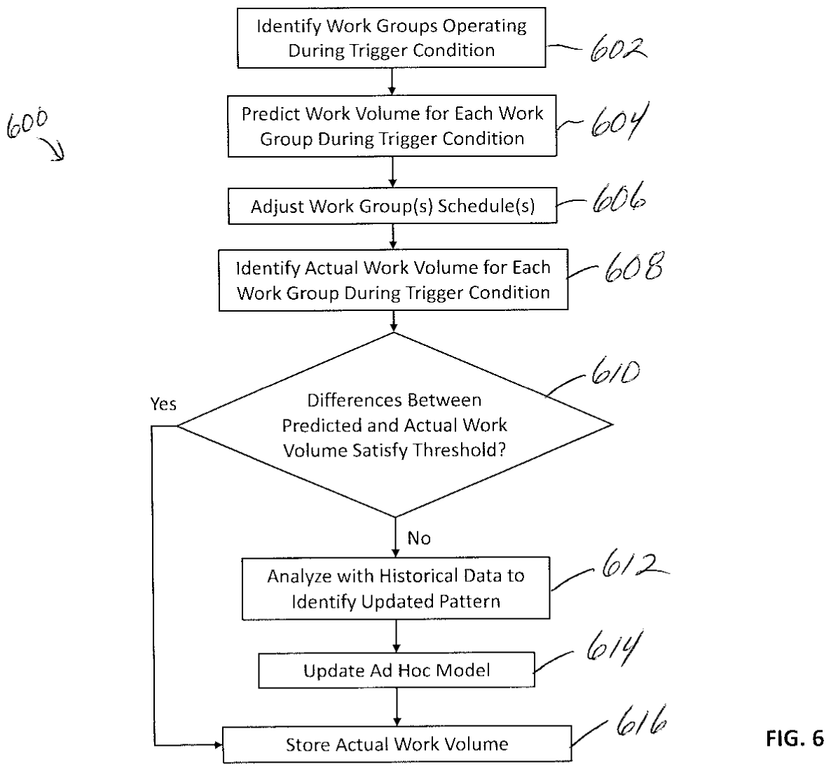

FIG. 6 illustrates a simplified flowchart of a method 600 that can be performed by the intelligent staff scheduling system 100 in connection with identifying variances between the predicted and actual work volumes different teams or groups of work staff experienced in connection with a trigger condition. The method 600 corresponds to, or is otherwise associated with, performance of the blocks described below in the illustrative sequence of FIG. 6. It should be appreciated, however, that the method 600 can be performed in one or more sequences different from the illustrative sequence.

At block 602, the work groups that will, or are, working or operating during a predicted or actual trigger condition can be identified, such as, for example, by the schedule system 138 and/or the intelligent staffing computing device 122. The work groups can correspond to a variety of departments or tasks within a business. For example, with respect to the insurance industry, a work group can consist of a first work group comprising employees that are to address inbound customer calls and/or customer claims relating to fire related damage, a second work group comprising employees that are to address inbound customer calls and/or customer claims relating to wind related damage, a third work group comprising employees that are to address inbound customer calls and/or customer claims relating to flood related damage, among other work groups.

Based on the type of trigger condition forecasted and/or detected, at block 604, the ad hoc model can be utilized by the neural network 130 to provide a prediction of a work volume one or more of each the work groups may experience in response to the trigger condition. For example, in the event of a forecast or prediction of relatively heavy rains in a particular area having an identified PIF count, the ad hoc model can be used to predict a possible increase in work load or volume that the first, second, and third work groups may, or may not, experience. Using such a prediction, work schedules can be adjusted

At block 608, data associated with the actual work load that one or more of the different work groups experienced as a result of the trigger condition can be identified, such as, for example, by the schedule system 138 and/or the intelligent staffing computing device 122. Again, the actual work load or volume experienced by each work group can be represented in a number of different manners, including, for example, via the inbound call volume, wait times, hold times, and/or service levels, among other data, associated with the queue system 106 and/or the workflow system 108 during one or more time periods or intervals before, during, and/or after the trigger condition.

At block 610, for each work group, the actual work load or volume, as provided by block 608, and can be evaluated with respect to the predicted work volume, as provided by block 604. Such an evaluation can include an evaluation of the differences in the predicted and actual workloads or volumes with a predetermined threshold value that can be indicative of whether staffing was, or was not, adequate or overabundant to provide a particular selected level of service, during the trigger event, as discussed above. If, for at least one or more work groups, the threshold is not satisfied, then, at block 612, for those work groups, the neural network 130 can analyze the data provided by block 608 with historical data to further identify, or refine, one or more patterns associated with the characteristics of the trigger condition and the resulting workload or volume for each of the one or more work groups. As previously discussed, such additional information, as provided by block 608, and/or an identification or refinement of a pattern(s) at block 612 can, for each of the one or more work groups, be utilized at block 614 by the neural network 130 to update or further refine the ad hoc model utilized for each particular work group. Further, regardless of whether the threshold was, or was not, determined to be satisfied at block 610, at block 616 the data accumulated at block 608 can be stored, such as, for example, in the historical database 126.

While the invention has been described in connection with what is presently considered to be the most practical and preferred embodiment, it is to be understood that the invention is not to be limited to the disclosed embodiment(s), but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore it should be understood that while the use of the word preferable, preferably, or preferred in the description above indicates that feature so described may be more desirable, it nonetheless may not be necessary and any embodiment lacking the same may be contemplated as within the scope of the invention, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

1. A system for generating predictions by a neural network for staffing scheduling in response to a detection or prediction of a trigger condition, the system comprising:
one or more databases that receive neural network training data corresponding to a plurality of characteristics for each of a plurality of past trigger conditions and a recorded work load associated with each of the plurality of past trigger conditions;
at least one processor;
a memory coupled to the at least one processor, the memory including instructions that, when executed by the at least one processor, cause the system to:
analyze, for continuous training of the neural network based on machine learning, the neural network training data to identify one or more work load patterns corresponding to one or more of the plurality of past trigger conditions;
receive a notification of the trigger condition;
receive, in response to notification of the trigger condition, a work load prediction from the neural network, the work load prediction based in part on the continuous training of the neural network and one or more characteristics of the trigger condition;
compare the work load prediction with a current staffing schedule and, based at least in part on an outcome of the comparison, adjust one or more work schedules of the current staffing schedule; and
automatically communicate the adjustment to the one or more work schedules to a client device.

2. The system of claim 1, wherein the memory further includes instructions that, when executed by the at least one processor, cause the system to identify one or more individuals, teams, groups, and/or departments to reallocate to assist with a predicted change in a work load, the predicted change in the work load being at least partially based on the work load prediction from the neural network.

3. The system of claim 1, wherein the memory further includes instructions that, when executed by the at least one processor, cause the system to retrieve the current staffing schedule from a staffing system.

4. The system of claim 1, wherein the one or more databases comprise a weather database, a historical database, and a current database.

5. The system of claim 4, wherein the trigger condition is a weather event.

6. The system of claim 4, further comprising one or more queue systems having one or more call centers.

7. The system of claim 6, wherein the trigger condition corresponds to at least one of a volume of a plurality of inbound calls received by the one or more call centers, a rate the plurality of inbound calls are received by the one or more call centers, a wait time for the plurality of inbound calls received by the one or more call centers, and a hold time for the plurality of inbound calls received by the one or more call centers.

8. The system of claim 7, wherein the memory further includes instructions that, when executed by the at least one processor, further cause the system to monitor a level of service provided to inbound calls received by the one or more call centers, and determine whether the level of service satisfies a predetermined threshold.

9. The system of claim 1, wherein the memory further includes instructions that, when executed by the at least one processor, further cause the system to:
record an actual work load level generated by the occurrence of the trigger condition; and
evaluate an accuracy of the work load prediction using the actual work load level, and
wherein a result from the evaluation of the accuracy of the work load prediction is added to the neural network training data.

10. The system of claim 1, wherein the memory further includes instructions that, when executed by the at least one processor, further cause the system to identify a number of policies in force anticipated to be impacted by the trigger condition, and wherein the work load prediction is further based in part on the identified number of policies in force.

11. A method for generating predictions by a neural network for staffing scheduling in response to a detection or prediction of a trigger condition, the method comprising:
receiving, by one or more databases, neural network training data corresponding to a plurality of characteristics for each of a plurality of past trigger conditions and a recorded work load associated with each of the plurality of past trigger conditions;
analyzing, for continuous training of the neural network based on machine learning, the neural network training data to identify one or more work load patterns corresponding to one or more of the plurality of past trigger conditions;
receiving a notification of the trigger condition;
receiving, in response to notification of the trigger condition, a work load prediction from the neural network, the work load prediction based in part on the continuous training of the neural network and one or more characteristics of the trigger condition;
comparing the work load prediction with a current staffing schedule and, based at least in part on an outcome of the comparison, adjust one or more work schedules of the current staffing schedule; and
automatically transmitting a signal communicating the adjusted one or more work schedules to a client device.

12. The method of claim 11, further including identifying one or more individuals, teams, groups, and/or departments to reallocate to assist with a predicted change in a work load, the predicted change in the work load being at least partially based on the work load prediction from the neural network.

13. The method of claim 11, further comprising retrieving the current staffing schedule from a staffing system.

14. The method of claim 11, wherein the one or more databases comprise a weather database, a historical database, and a current database.

15. The method of claim 14, wherein the trigger condition is a weather event.

16. The method of claim 14, wherein the current staffing schedule comprises a staffing schedule for one or more call centers.

17. The method of claim 16, wherein the trigger condition corresponds to at least one of a volume of a plurality of inbound calls received by the one or more call centers, a rate the plurality of inbound calls are received by the one or more call centers, a wait time for the plurality of inbound calls received by the one or more call centers, and a hold time for the plurality of inbound calls received by the one or more call centers.

18. The method of claim 17, further comprising monitoring a level of service provided to inbound calls received by the one or more call centers, and determine whether the level of service satisfies a predetermined threshold.

19. The method of claim 11, further comprising:
recording an actual work load level generated by the occurrence of the trigger condition;
evaluating an accuracy of the work load prediction using the actual work load level; and
supplementing the neural network training data to include a result from the evaluation of the accuracy of the work load prediction.

20. The method of claim 11, further comprising identifying a number of policies in force anticipated to be impacted by the trigger condition, and wherein the work load prediction is further based in part on the identified number of policies in force.
